(19) United States
(12) Patent Application Publication
(10) Pub. No.: US 2026/0092660 A1
(43) Pub. Date: Apr. 2, 2026

(54) CONNECTOR FOR CONDUITS

(71) Applicant: MAXI-DRAIN INC., Sainte-Françoise (CA)

(72) Inventors: Alain LEMAY, Sainte-Françoise (CA); François GOUPIL, Sainte-Françoise (CA)

(21) Appl. No.: 19/343,655

(22) Filed: Sep. 29, 2025

Related U.S. Application Data
(60) Provisional application No. 63/701,063, filed on Sep. 30, 2024.

(51) Int. Cl. F16L 25/00

(52) U.S. Cl. CPC F16L 25/0063; F16L 25/0045

(57) ABSTRACT

A connector to fluidly connect ends of conduits. The connector comprises a connector tubular body which includes a wall, a stopper and one or more conduit-retainer. The wall has an inner and outer surface, with a first conduit-receiving section and a second conduit-receiving section being defined at a first and second ends of the wall, respectively. Each of the first and second conduit-receiving sections are configured to internally and concentrically receive an end portion of a conduit. The stopper extends radially inward from the inner surface of the wall, between the first and the second conduit-receiving sections and is provided with a seal on each side of the stopper adapted to restrict fluid leakage when conduits are installed in the connection. The at least one conduit-retainer extends inwardly from the inner surface of the wall. The at least one conduit-retainer being lockably engageable with a conduit being received.

### CROSS REFERENCE TO RELATED APPLICATIONS

The present application claims priority to U.S. Provisional Application No. 63/701,063, filed Sep. 30, 2024, entitled “Connector for Conduits.” The aforementioned application is hereby incorporated by reference in its entirety.

### TECHNICAL FIELD

The present application relates to the connection of conduits in various applications ranging from water drainage to industrial transport of fluids.

### BACKGROUND

Connecting conduits is a fundamental aspect in plumbing, water systems, oil and gas distribution, and other industrial applications.

In the field of plumbing and effluent discharge, various challenges require a practical solution for connecting conduits.

A multiplicity of solutions exist to connect conduits: welding, flanging, threaded connections, soldering/blazing, compression fitting, solvent welding, bell and spigot connections, etc. For every solution, the main objectives are: providing a continuous alignment between the two conduits, maintaining pressure integrity of a fluid flowing therein, providing sealing, avoiding misalignment/disengagement of conduits, ensuring durability and provide ease of installation.

The conduit connector design impacts, for instance, equipment price, number of installations and production steps needed, labor cost and installation safety. Furthermore, conduit size is also a determining factor in choosing the right conduit connector solution. Indeed, some connector technologies better apply to small conduits and others to bigger conduits.

Threaded connections and compression fitting are two solutions commonly used to connect conduits but they come with their own drawbacks. For instance, threaded connections are inadequate for large conduits as it is difficult to rotate them for installation. Compression fitting may not be suitable for fragile conduits that break under compression and can thus break while fastening coupling collars. There is thus a need to provide an improved conduit connector.

### BRIEF SUMMARY

The present embodiments include couplers (i.e., connectors) which may be qualified as double bell snap couplers. However, this appellation is not meant to be limitative. The present embodiments provide a solution to: (i) establish a continuous fluid communication line by connecting two conduits; (ii) avoiding fluid leaks by sealing the two conduit ends and reducing relative conduits movement; (iii) providing a versatile sealing; (iv) minimizing misalignment or disengagement of the conduits; (v) improving durability; and (vi) providing ease of installation. Also, the present embodiments may be adjustable to a variety of conduit sizes, shapes (e.g., entirely or partially corrugated). The present embodiments may be used for coupling conduits in different orientation, e.g., vertical or horizontal conduit coupling.

The present embodiments include a tubular connector comprising a connector tubular body extending along a longitudinal axis, the connector tubular body comprising: a wall extending axially from a bottom end to a top end, the wall having an inner surface and an outer surface; a first conduit-receiving section at the top end of the connector tubular body; a second conduit-receiving section at the bottom end of the connector tubular body, the first conduit-receiving section and the second conduit-receiving section being configured to internally and concentrically receive an end of a fluid conduit; a stopper positioned between the first conduit-receiving section and the second conduit-receiving section, the stopper extending radially inward from the inner surface of the wall in a flat ring having a first face towards the first conduit-receiving section and a second face towards the second conduit-receiving section, the stopper being configured to allow passage of fluids in the fluid conduits and halt forward progress of the end of the fluid conduits once the fluid conduits are inserted in each of the top and bottom end of the connector, the connector also having at least two conduit-retainers extending radially inward from the tubular connector wall and spaced apart in relation to each top face and bottom face of the stopper, the at least two conduit-retainers being configured to engage the fluid conduit once installed in the connector. In embodiments at least the terminal portion of the fluid conduits being corrugated and configured to be gripped during installation in the connector by at least two conduit-retainers; and a seal covering each of the first face and second face of the stopper, the seal being compressible in abutment to the end of the fluid conduits installed in the connector and the seals being configured to slow or to prevent passage of fluids out of the connector and out of the fluid conduits.

In the present embodiments, the seal may be made of any compressible material capable of controlling or stopping leakage of fluids carried in conduits and joined by a connector. For example, the seal material may be selected from the group consisting of: Rubber Compounds, Thermoplastics, Teflon/PTFE and Elastomers.

In the present embodiments the wall may be cylindrical.

In the present embodiments, the at least one conduits-retainers are particularly useful for installation of the conduits in the connectors. Indeed, while connecting two conduits, particularly of a great size, the conduit-retainers are holding the conduits in an engaged position in the first and second conduit-receiving sections of the connector. During installation, conduit movements are frequent and imply additional labor. Another advantage of the conduit-retainer is to limit the number of external retainment of the conduit, using stands, clamps, hydraulic or pneumatic conduit installation tools. For instance, a full installation team needed to produce further retainment of the conduit may be approximately thousands of CAD per tubular connector installation, taking into account the use of vehicles. The user may appreciate the reduction of labour cost and time by using, among others, the tubular connector of the present embodiments.

### BRIEF DESCRIPTION OF THE FIGURES

FIG. 1 is a top perspective view of a connector having a connector cylindrical body, according to an embodiment.

FIG. 2 is a cross-section view of the connector shown in FIG. 1, shown connecting two corrugated conduits.

FIG. 3 is a side perspective view of the cross-section of the connector connecting two conduits shown in FIG. 2.

### DETAILED DESCRIPTION

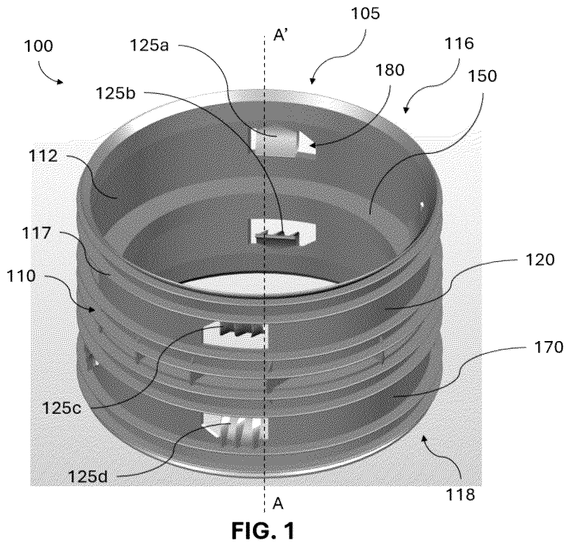

The terms axial, radial, tangential, longitudinal, inward, outward and cross-section, or any variation thereof, that may be used in this description, are defined in relation to the longitudinal axis AA′ (shown in FIG. 1).

FIG. 1 is an exemplary embodiment of a connector 100 extending along a longitudinal axis AA′. The connector 100 is adapted to receive and fluidly connect two conduits having end portions, as explained in more details below.

The term “cylindrical”, or any variation thereof as used herein, can be generally understood as relating to the form of a cylinder, and does not exclude polygonal shapes of the connector boundaries. Similarly, the term “tubular”, or any variation thereof as used herein, refers to a substantially hollow body having two connected openings, and is not limited to a hollow body having a strictly cylindrical shape, as other tubular cross-section shapes are considered herein, such as triangle-shapes and square-shapes, for example. It is also understood that a tubular element can be curved.

In some embodiments, the connector 100 may be made of any material suitable for connecting conduits, e.g., metal, plastic and polymer, or any combination thereof. For instance, copper, PVC (Polyvinyl Chloride), concrete, CPVC (Chlorinated Polyvinyl Chloride), PEX (Cross-linked Polyethylene), Polypropylene (PP), Galvanized Steel and Stainless Steel.

The connector 100 includes a connector body 105 extending along the longitudinal axis AA′. The connector body 105 may have an inner radial diameter of between 4″ to 48″, preferably 10″ to 48″. In the embodiment shown in FIGS. 1 to 3, the connector cylindrical body 105 includes a wall 110. The wall 110 extends axially from a first end 116 to a second end 118 (FIG. 1). The wall 110 has an inner surface 112 and an outer surface 117. With reference to the embodiment shown, the wall 110 has one face (i.e., the inner surface 112). In other embodiments (not shown), the wall 110 has at least three faces, for instance 3, 4, or more faces, defining a triangular shape, square-shape, etc., when viewed from a cross-section perspective, such that the plurality of faces together define the inner and outer surfaces of the wall.

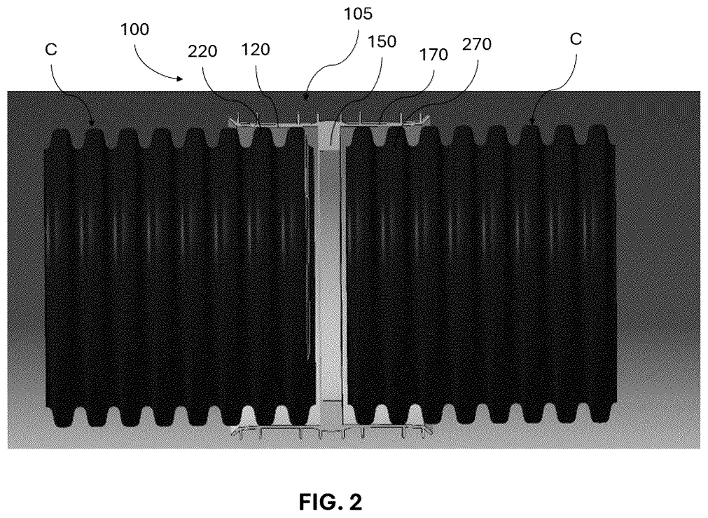

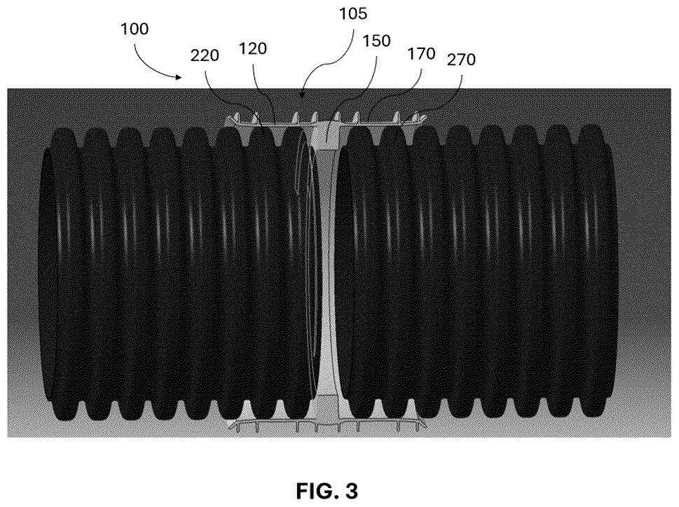

According to the same embodiment, and as better shown in FIGS. 2 and 3, the connector 100 further includes a stopper 150 that extends radially inward from the inner surface 112 of the wall 110. The stopper 150 is configured to halt longitudinal progress of one or more conduits C being inserted into the connector cylindrical body 105. According to the embodiment, the stopper 150 has a length such that a free end of the stopper 150 is levelled with an extremity of the conduit opening of the corresponding conduit C, so that the conduit C may abut the stopper 150 in engagement. The stopper 150 comprises a first face and an opposite second face, the first face and the second face respectively facing the first end 116 and the second end 118 of the wall 110.

Still referring to the embodiment shown in FIGS. 1 to 3, the wall 110 of the connector 100 further defines a first conduit-receiving segment 120 between the first end 116 of the wall 110, and a second conduit-receiving segment 170 defined between the second end 118 of the wall 110 and the stopper 150. The first and second conduit-receiving sections 120, 170 are correspondingly sized and shaped to internally and concentrically receive a conduit end portion 220, 270 of a conduit C, as described in more details below.

According to an alternative embodiment having at least three faces, as previously mentioned, the stopper 150 is shaped in accordance with the number of faces of the wall 110. For example, an embodiment (not shown) of the connector including a wall having three faces—thus resulting in a connector (cylindrical) body having a triangular prism shape—the stopper extends inwardly from the face(s) of the wall. In some other embodiments, the stopper has alternate peaks and valleys, or recesses. In other embodiments, the connector cylindrical body is tubular.

Referring again to the embodiment of the connector 100 shown in FIG. 1, at least one conduit-retainer 125, and more specifically four conduit-retainers 125a, 125b, 125c, 125d, extend inward from the wall 110. The conduit-retainers 125 may be extending inward from the inner surface 112 of the wall 100, from the outer surface 117 of the wall 100, or from between the inner surface 112 and the outer surface 117 of the wall 110. More specifically, each conduit-retainer 125a, 125b, 125c, 125d shown includes a tab (i.e., a clip), preferably resilient and extending from the inner surface 112 of the wall 110 toward the axis A to A′. The conduit-retainers 125 may also include reinforcing structures (e.g., added material in any form) on the conduit-retainer to increase the robustness and durability of the conduit-retainers 125. As shown, the connector 100 may include conduit-retainers oppositely located in the first and second conduit-receiving segments 120, 170. Alternatively, the conduit-retainers may be arranged within a single conduit-receiving segment (e.g., an embodiment featuring only first and third conduit-retainers 125a, 125c from FIG. 1). In alternative embodiments (not shown), the connector may include a fifth or a sixth conduit-retainer, or only include a first and second conduit-retainer, for instance. Thus, the number and arrangement of conduit-retainers showcased in FIGS. 1 to 3 is not meant to be limitative.

In accordance with the embodiment of FIG. 1, the conduit-retainers 125a, 125b, 125c, 125d can be “arc-shaped”, in that at least a portion of the conduit-retainer extends and curves towards the stopper 150. An arc shape of the conduit-retainer adds at least some resilience against longitudinal disengagement of the conduit C from the connector 100. Other shapes of the conduit-retainer adapted to engage and lock onto an outside surface of a conduit C are contemplated herein. Still referring to FIG. 1, the conduit-retainers shown are curved tabs. Moreover, it is understood that a radial length of the conduit-retainer 125 is adapted to lockingly engage an outside surface of a corresponding conduit C without interfering with the reception of the conduit end portions 220, 270 into the connector body 105.

In some embodiments, the conduits-retainers 125a, 125b, 125c, 125d may be pulled back towards the wall 110 to remove the conduits that are received in the connector body 105. As provided in the embodiment shown in FIG. 1, to facilitate access to the conduit-retainers, apertures 180 (i.e., access apertures 180) are provided in the wall 110, proximate each conduit-retainer 125a, 125b, 125c, 125d. As such, a user may grasp, and for instance pull and bend, the conduit-retainer to disengage the outside surface of the conduit C. It is appreciated that the conduit-retainers 125a, 125b, 125c, 125d can be made of a resilient material.

In some embodiments (not shown), a compressible seal covers at least part of the stopper 150. The seal can prevent passage of fluids between the stopper 150 and a conduit C via a substantially leakproof connection, as further described below.

In the embodiment shown in FIGS. 1 to 3 (and as better shown in FIG. 1), the stopper 150 extends continuously along a periphery of the inner surface 112 of the wall 11, and more specifically along an inner circumference of the cylindrical wall 110. It will be appreciated that providing a stopper 150 (with or without a seal) generally limits fluid leakage (and to the access apertures 180).

FIG. 2 shows an embodiment of the connector 100 receiving a first conduit end portion 220 in the first conduit-receiving segment 120 and a second conduit end portion 270 in the second conduit-receiving segment 170.

According to the embodiment shown in FIG. 2, the conduit-receiving segment 120, 170 are configured to internally and concentrically receive the conduit end portions 220, 270. For example, the first and second conduit-receiving segments 120, 170 are sized and shaped to receive a correspondingly conduit C format. It is appreciated that in some embodiments, the connector 100 may include the conduit-retainers 125a, 125b, 125c, 125d (as shown in FIG. 1) to lockably engage the conduits end portions 220, 270. In these embodiments, the conduit end portions 220, 270 may have peaks and valleys or any other surface morphology that allow the conduit-retainers 125a, 125b, 125c, 125d to lockably engage the conduits end portions 220, 270. This said, the embodiments of the conduit-receiving segments described herein may be lockingly engageable with a conduit having a substantially flat surface.

According to an alternative embodiment (not shown), the conduits end portions 220, 270 may be configured to engage the conduit-retainers 125 in a similar manner to a ratchet rack of a linear ratchet mechanism.

Yet in other embodiments, the conduits end portions 220, 270 may be shaped to fit into a connector 100 having a wall 110 having 3, 4, 5 or more faces, as explained above.

In some embodiments and as stated above, the compressible seal (not shown), covering at least some part of the stopper 150, at least partially prevents passage of fluids between the stopper 150 and the conduits end portions 220, 270 received in the connector 100. The substantially leakproof sealing can be provided by a contact between the conduits end portions 220, 270 and the compressible seal. Alternatively, the substantially leakproof sealing can be made by applying external pressure to the conduit end portions 220, 270, e.g., by pushing the conduits C into the connector 100, thereby compressing the seal. The seal is present on the two faces of the stopper 150. Each face is positioned to respectively face one of the conduits end portions 220, 270.

The substantially leakproof sealing may therefore be achieved from a low pressure on the seal throughout any stage of the compression of the seal by applying external pressure via the conduits end portions 220, 270 that are received into the conduit-receiving segments 120, 170 of the connector 100.

The leakproof sealing characteristic of the compressible seal at any compression can ease installation and operation of the connector 100. Indeed, a seal on the stopper 150 provides room to maneuver the position of each conduit end portions 220, 270 in the first and second conduit-receiving segments 120, 170. Therefore, the substantially leakproof sealing may be achieved even if the conduits C, and thus the conduit ends, that are received by connector 100 are displaced or otherwise disturbed because of external factors.

In some embodiments, the compressible seal may comprise any material that is compressible and impermeable. Examples of materials are: PTFE (polytetrafluoroethylene), Nitrile Rubber (Buna-N), Silicone Rubber, Neoprene (Polychloroprene), Polyurethane, Viton (Fluoroelastomer), PVC (Polyvinyl Chloride), PMMA (Polymethyl methacrylate) Natural Rubber or other forms of compressible elastomeric material.

In other embodiments, the compressible seal may be a foam that provides a substantially leakproof sealing within the connector. For instance, the foam may comprise: Closed-Cell Polyethylene, Polyurethane, Expanded Polystyrene (EPS), Extruded Polystyrene (XPS), Ethylene-Vinyl Acetate (EVA), Cross-linked Polyethylene (XLPE), Polyvinyl Chloride (PVC) or Neoprene.

Yet in other embodiments, the compressible seal may comprise a combination of a foam and an impermeable material layer or repellent material layer covering the foam. In this embodiment, the foam may be impermeable or not. However, in this case, the seal may also entirely cover the surface of the stopper 150 in order to provide a leakproof sealing and thus prevent passage of fluids between the stopper 150 and the conduit end portions 220, 270 received in the connector 100.

In some embodiments, the compressible seal may be already present on the stopper 150 of the connector 100. In other words, the compressible seal can be integrally part of the stopper 150.

In other embodiments, the compressible seal may be installed on the stopper 150 by the user before lockably engaging the conduit end portions 220, 270 in their respective conduit-receiving segments 120, 170.

In some embodiments, the conduit ends comprise peaks and valleys or recesses, spaced apart of a distance which is smaller than the thickness of the compressible seal. This allows the conduits retainers 125 and 175 to lockably engage the conduits end portions 220, 270 at different external pressures applied via the conduits end portions 220, 270—that are received into the conduit-receiving segments 120, 170 of the connector 100—to the compressible seal. Thereby, a leakproof sealing is obtained at a desired compression of the seal.

According to one configuration, the connector 100 may be used to horizontally connect two conduits for water drainage or any other use, e.g., industrial effluent drainage. According to one mode of installation of the connector 100, the seal is installed on the stopper (if not already present on—or integral with—the stopper 150). Further in the installation, a first conduit end portion 220 is received concentrically and internally in the first conduit-receiving segment 120 of the connector 100 and is lockably engaged by the conduit-retainers 125a, 125b, 125c, 125d. Then, before, or simultaneously, a second conduit end portion 270 is received concentrically and internally in the second conduit-receiving segment 170 of the tubular connector 100 and is lockably engaged by the conduit-retainers 125. In some embodiments, the conduit end portions 220, 270 may be received in any one of the conduit-receiving segments 120, 170 interchangeably.

In the present description, an embodiment is an example or implementation. The various appearances of “one embodiment”, “one embodiment”, “an embodiment” or “some embodiments” do not necessarily all refer to the same implementation or embodiment. Although various features may be described in the context of a single implementation, the features may also be provided separately or in any suitable combination. Conversely, although the invention may be described herein in the context of separate implementations for clarity, it may also be implemented in a single embodiment. Reference in the specification to “some embodiments”, “an embodiments”, “one embodiment” or “other embodiments” means that a particular feature, structure, or characteristic described in connection with the embodiments or embodiment is included in at least some embodiments, but not necessarily all embodiments.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

It will be appreciated that the methods described herein may be performed in the described order, or in any suitable order.

Several alternative embodiments, implementations and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A connector for fluidly connecting conduits having end portions, the connector comprising:
a connector tubular body extending along a longitudinal axis, the connector tubular body comprising:
a wall extending axially from a first end to a second end thereof, the wall having an inner surface and an outer surface;
a stopper extending radially inward from the inner surface of the wall, the stopper comprising a first face and an opposite second face, the first face and the second face respectively facing the first end and the second end of the wall;
a first conduit-receiving segment defined between the first end of the wall and the stopper;
a second conduit-receiving segment defined between the second end of the wall and the stopper, and
each of the first conduit-receiving segment and the second conduit-receiving segment being configured to internally and concentrically receive an end portion of a correspondingly shaped conduit; and
a seal being configured to receive in abutment an end portion of a conduit.

2. The connector of claim 1, wherein the seal integrally covers the first face and the second face of the stopper.

3. The connector of claim 1, the seal being compressible.

4. The connector of claim 1, the seal being made of a material selected from the group consisting of: Rubber Compounds, Thermoplastics, Teflon/PTFE and Elastomers.

5. The connector of claim 1, the seal comprising a compressible foam covered by a liquid repellent layer.

6. The connector of claim 1, the connector tubular body further comprising at least one conduit-retainer extending inwardly from the wall, the at least one conduit-retainer being lockably engageable with an outer surface of the end portion of the conduit being internally and concentrically received in a respective one of the first conduit-receiving segment and the second conduit-receiving segment.

7. The connector of claim 6, the at least one conduit-retainer being a resilient tab configured to lockingly engage the outer surface of the end portion of the conduit.

8. The connector of claim 6, the at least one conduit-retainer extending at least in part towards the stopper.

9. The connector of claim 6, the wall of the connector tubular body defining an aperture proximate the at least one conduit-retainer.

10. The connector of claim 6, the at least one conduit-retainer being at least two conduit-retainers, the at least two conduit-retainers comprising a first conduit-retainer and a second conduit-retainer extending in the first and second conduit-receiving segments, respectively.

11. The connector of claim 1, the connector tubular body being a cylindrical body.
